(19) United States
(12) Patent Application Publication
(10) Pub. No.: US 2019/0384127 A1
(43) Pub. Date: Dec. 19, 2019

(54) DISPLAY PANEL AND METHOD FOR MANUFACTURING THE SAME

(71) Applicants: HKC Corporation Limited; Chongqing HKC Optoelectronics Technology Co., Limited

(72) Inventor: Yu-Jen CHEN, Chongqing (CN)

(21) Appl. No.: 15/550,660

(22) PCT Filed: May 31, 2017
(86) PCT No.: PCT/CN2017/086640

§ 371 Date: Aug. 11, 2017

(30) Foreign Application Priority Data
Mar. 30, 2017 (CN) 201710204001.1

(51) Int. Cl. G02F 1/1362; G02F 1/1333

(52) U.S. Cl. CPC G02F 1/136209; G02F 2201/40; G02F 2001/133368; G02F 1/1333

(57) ABSTRACT

This application relates to a display panel and a method for manufacturing same. The display panel includes: a first substrate; a plurality of pixel units, disposed on the first substrate; a protection layer, disposed on the first substrate and covering the pixel units, where in each of the pixel units, the protection layer is divided into a plurality of light pervious areas with different thicknesses; and a transparent electrode layer, disposed on the protection layer, and covering the light pervious areas with different thicknesses of the protection layer.

### BACKGROUND

### Technical Field

This application relates to a display panel and a method for manufacturing the same, and in particular, to a display panel having a protection layer with different thicknesses and a method for manufacturing the same.

### Related Art

In recent years, with progress of technologies and diversification of demands of people, liquid crystal displays (LCDs) have been widely applied to various aspects of human life. Most of LCDs are backlight LCDs. A backlight LCD is formed by a liquid crystal display panel and backlight module.

A liquid crystal display panel is usually formed by a color filter (CF) substrate, a thin film transistor array substrate (TFT array substrate), and a liquid crystal layer (LC layer) disclosed between the two substrates. An operating principle of the liquid crystal display panel is to apply a drive voltage to two glass substrates to control rotation of liquid crystal molecules of the LC layer, so as to refract light rays of a backlight module to generate an image.

With respect to LCDs in vertical alignment (VA) modes, such as a patterned vertical alignment (PVA) LCD or a multi-domain vertical alignment (MVA) liquid crystal display apparatus, the PVA LCD achieves an effect of a wide viewing angle by using an fringe field effect and a compensation plate, and the MVA LCD divides one pixel into a plurality of areas, and makes, by using a protrusion or a specific pattern structure, liquid crystal modules located in different areas topple towards different directions, to achieve a wide viewing angle and improve a penetration rate.

In the MVA mode, currently, the mainstream is to divide a pixel into a bright area and a dark area, and therefore in optical performance, two V-T attributes may be mixed, and by appropriately adjusting an area ratio between the bright and dark areas, the problem of middle grayscale whitening may be effectively suppressed in a case of a large viewing angle.

### SUMMARY

To resolve the foregoing technical problem, an objective of this application is to provide a display panel having a protection layer with different thicknesses and a method for manufacturing same, so as to not only improve a pixel aperture ratio, but also improve a color shift condition of the display panel.

The objective of this application is achieved and the technical problem thereof is resolved by using the following technical solutions. A display panel provided according to this application includes: a first substrate; a plurality of pixel units, disposed on the first substrate; a protection layer, disposed on the first substrate and covering the pixel units, where in each of the pixel units, the protection layer is divided into a plurality of light pervious areas with different thicknesses; and a transparent electrode layer, disposed on the protection layer, and covering the light pervious areas with different thicknesses of the protection layer.

The objective of this application may further be achieved and the technical problem thereof may further be resolved by using the following technical measures.

In an embodiment of this application, the light pervious areas of each of the pixel units are divided into a primary light pervious area having a first thickness, a secondary light pervious area having a second thickness, and a second secondary light pervious area having a third thickness according to different thicknesses of the light pervious areas.

In an embodiment of this application, a thickness difference between the primary light pervious area and the secondary light pervious area, and a thickness difference between the secondary light pervious area and the second secondary light pervious area is equal to or greater than 1 um.

In an embodiment of this application, the protection layer is a flat layer or a passivation layer of a material of silicon nitride and a compound thereof.

Another objective of this application is a method for manufacturing a display panel, including: providing a first substrate, where the first substrate includes a plurality of pixel units; forming a color resist layer on the first substrate; forming a protection layer on the first substrate, where the protection layer covers the color resist layer; patterning the protection layer, so that the protection layer forms a plurality of different thicknesses on each of the pixel units; forming a transparent electrode layer on the patterned protection layer; and patterning the transparent electrode layer, exposing part of the protection layer, and forming a black matrix layer and a plurality of photo spacers on the exposed protection layer.

In an embodiment of this application, the light pervious areas of each of the pixel units are divided into a primary light pervious area having a first thickness, a secondary light pervious area having a second thickness, and a second secondary light pervious area having a third thickness according to different thicknesses of the light pervious areas.

In an embodiment of this application, a thickness difference between the primary light pervious area and the secondary light pervious area, and a thickness difference between the secondary light pervious area and the second secondary light pervious area is equal to or greater than 1 um.

In an embodiment of this application, when the protection layer is patterned, the protection layer is patterned by using a half-tone mask, and the mask comprises a pervious area, a half-pervious area, and a non-pervious area, so that the patterned protection layer has different thicknesses.

In an embodiment of this application, the protection layer is a flat layer or a passivation layer of a material of silicon nitride and a compound thereof.

Another objective of this application is to provide a display apparatus, including a backlight module and a display panel. The display panel includes: a first substrate; a plurality of pixel units, disposed on the first substrate; a protection layer, disposed on the first substrate and covering the pixel units, where in each of the pixel units, the protection layer is divided into a plurality of light pervious areas with different thicknesses; a transparent electrode layer, disposed on the protection layer, and covering the light pervious areas with different thicknesses of the protection layer; a second substrate, disposed opposite to the first substrate; and a liquid crystal layer, disposed between the first substrate and the second substrate.

This application not only can improve a pixel aperture ratio, but also can improve a color shift condition of the display panel.

### BRIEF DESCRIPTION OF THE DRAWINGS

FIG. 1a is penetration rate-grayscale value curves corresponding to color shift angles of a display apparatus in cases of a 0-degree viewing angle, a 45-degree viewing angle, and a 60-degree viewing angle according to an embodiment of this application;

FIG. 1b is a brightness-grayscale curve corresponding to two mixed improved color shift angles according to an embodiment of this application;

FIG. 2 is a model of a mixed low color shift area according to an embodiment of this application;

FIG. 3a is a schematic diagram of a protection layer with a gradient according to an embodiment of this application;

FIG. 3b is a schematic diagram of a display panel having a protection layer with a gradient according to an embodiment of this application;

FIG. 4 is a schematic diagram of a display panel having a protection layer with a gradient according to another embodiment of this application;

FIG. 5a is 3 GAMMA curves explained by using penetration rate-voltage curves according to an embodiment of this application;

FIG. 5b is 3 GAMMA curves explained by using penetration rate-grayscale value values according to an embodiment of this application; and

FIG. 6 is a schematic diagram of manufacturing of a protection layer with a gradient according to this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of the gravity direction.

To further describe the technical means adopted in this application to achieve the preset inventive objective and effects thereof, specific implementations, structures, features, and effects of a display panel and a method for manufacturing same provided according to this application are described below in detail with reference to the drawings and preferred embodiments.

A display apparatus of this application may include a backlight module and a display panel. The display panel may include a TFT substrate, a CF substrate, and an LC layer disposed between the two substrates.

In an embodiment, the display panel of this application may be a curved-surface display panel, and the display apparatus of this application may be a curved-surface display apparatus.

In an embodiment, a TFT or another active switch, and a CF of this application may be formed on a same substrate.

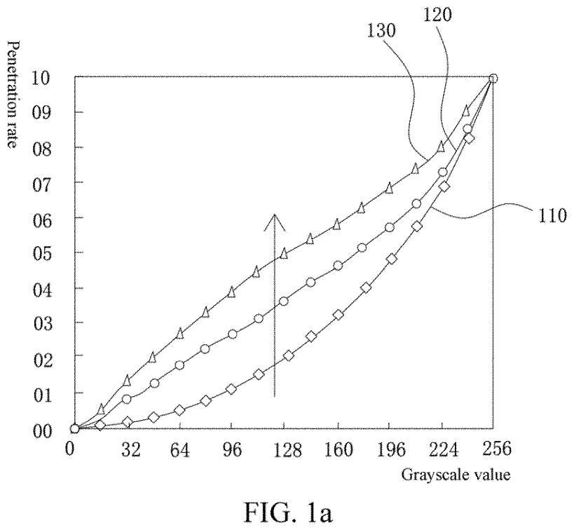

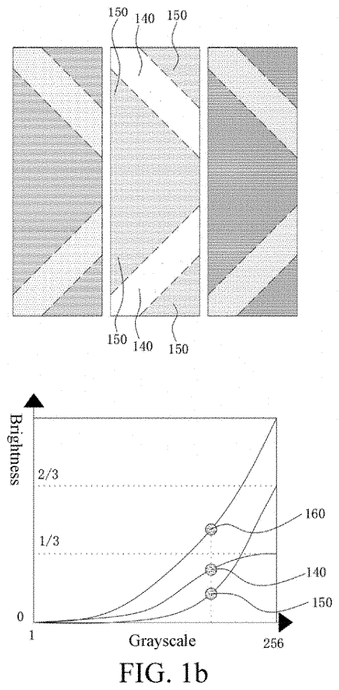

FIG. 1a is penetration rate-grayscale value curves corresponding to color shift angles of a VA liquid crystal display apparatus in cases of a 0-degree viewing angle, a 45-degree viewing angle, and a 60-degree viewing angle. Referring to FIG. 1a, a penetration rate-grayscale value curve 110 corresponding to a 0-degree color shift viewing angle, a penetration rate-grayscale value curve 120 corresponding to a 45-degree color shift viewing angle, and a penetration rate-grayscale value curve 130 corresponding to a 60-degree color shift viewing angle are shown. Therefore, in a same grayscale value, a higher color shift viewing angle indicates a higher brightness penetration rate.

FIG. 1b is a brightness-grayscale curve corresponding to two mixed improved color shift angles. Referring to FIG. 1b, in an MVA mode, a pixel may be divided into a pixel into a bright area and a dark area, and therefore in optical performance, two V-T attributes may be mixed, and by appropriately adjusting an area ratio between the bright and dark areas, the problem of middle gray-scale whitening may be effectively suppressed in a case of a large viewing angle. However, a bright-area pixel 140 and a dark-area pixel 150 are mutually mixed and adjusted into a pixel 160 in a brightness-grayscale drawing.

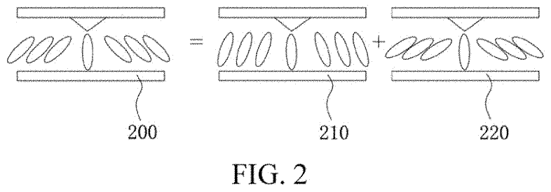

FIG. 2 is a model of a mixed low color shift area. Referring to FIG. 2, a main principle of a common low color shift technology is to further cut conventional 4 areas into 8 areas by means of voltage division or extra driving. Therefore, an effect of multi-domain compensation is presented when watching in a large viewing angle. For example, a sub low color shift area 210 and a primary low color shift area 220 mix with each other into a low color shift area 200.

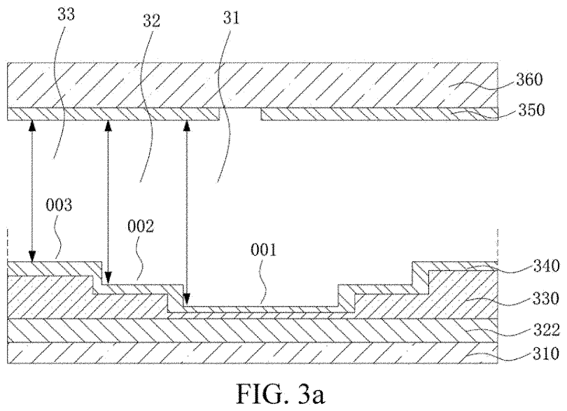

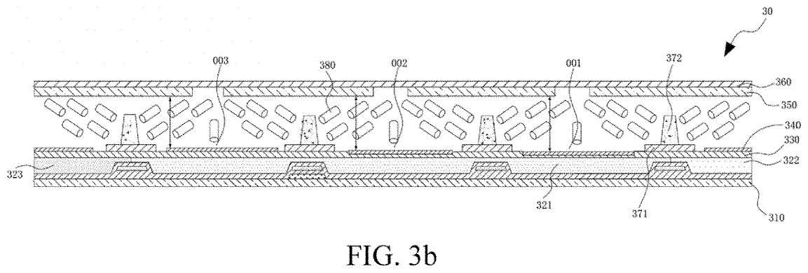

FIG. 3a is a schematic diagram of a protection layer with a gradient according to an embodiment of this application and FIG. 3b is a schematic diagram of a display panel having a protection layer with a gradient according to an embodiment of this application. A value of the gradient and thicknesses of steps of the protection layer may be determined according to requirements of designers, and in this embodiment, a case in which there are three thicknesses of steps is used as an example. Referring to FIG. 3a and FIG. 3b, in an embodiment of this application, a display panel 30 includes: a first substrate 310; a plurality of pixel units, disposed on the first substrate 310, where the pixel unit includes a first color resistor 321, a second color resistor 322, and a third color resistor 323 that are disposed in parallel; a protection layer 330, disposed on the first substrate 310, and covering the pixel units, where in each of the color resistors, the protection layer 330 is divided into at least three light pervious areas with different thicknesses; a black matrix layer 371 and a plurality of photo spacers 372, disposed on the protection layer 330; a transparent electrode layer 340, disposed on the protection layer 330, and covering the light pervious areas with different thicknesses of the protection layer 330; a second substrate 360, disposed opposite to the first substrate 310; a common electrode layer 350, disposed on the second substrate 360; and an LC layer 380, disposed between the first substrate 310 and the second substrate 360.

In an embodiment of this application, in each of the pixel units, the light pervious areas of the first color resistor, the second color resistor, and the third color resistors may be divided into a primary light pervious area 001 having a first thickness 31, a secondary light pervious area 002 having a second thickness 32, and a second secondary light pervious area 003 having a third thickness 33 according to different thicknesses of the light pervious areas.

In an embodiment of this application, a thickness difference between the primary light pervious area 001 and the secondary light pervious area 002, and a thickness difference between the secondary light pervious area 002 and the second secondary light pervious area 003 is equal to or greater than 1 um.

In an embodiment of this application, the protection layer 330 is a flat layer or a passivation layer of a material of silicon nitride and a compound thereof.

In an embodiment of this application, the black matrix layer 371 and the plurality of photo spacers 372 are made of a same material, and are integrally formed on the protection layer 330 by using a same mask process.

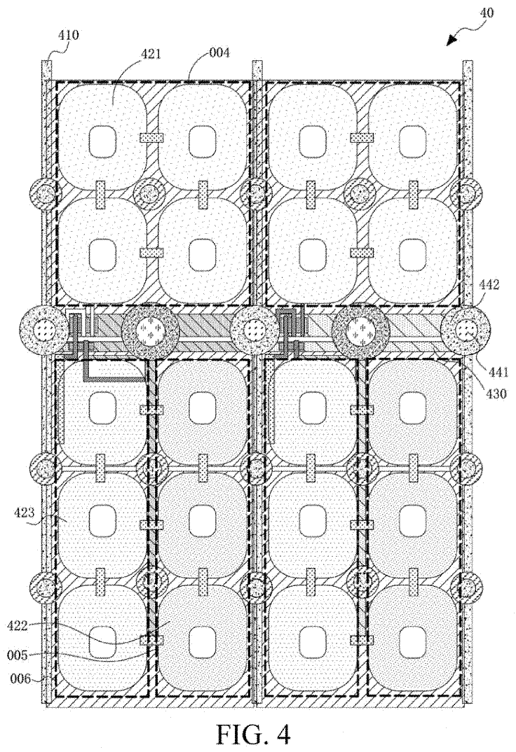

FIG. 4 is a schematic diagram of a display panel having a protection layer with a gradient according to another embodiment of this application. Referring to FIG. 4, in an embodiment of this application, a display panel 40 includes: a first substrate; a plurality of data lines 410, and a plurality of scanning lines 430, disposed on the first substrate, where the plurality of data lines 410 and the plurality of scanning lines 430 define a plurality of pixel areas, and each of the pixel areas includes a first color resistor 421, a second color resistor 422, and a third color resistor 423; a protection layer, disposed on the first substrate; and a black matrix layer 442 and a plurality of photo spacers 441, disposed on the first substrate, and covering the plurality of data lines 410 and the plurality of scanning lines 430, where in each of the pixel units, the protection layer is divided into at least three light pervious areas with different thicknesses; a transparent electrode layer, disposed on the protection layer, and covering the light pervious areas with different thicknesses of the protection layer; a second substrate, disposed opposite to the first substrate; a common electrode layer, disposed on the second substrate; and an LC layer, disposed between the first substrate and the second substrate.

In an embodiment of this application, in each of the pixel units, the light pervious areas may be divided into a primary light pervious area 004 having a first thickness and covering the first color resistor 421, a secondary light pervious area 005 having a second thickness and covering the second color resistor 422, and a second secondary light pervious area 006 having a third thickness and covering the third color resistor 423 according to different thicknesses of the color resistors and the protection layer.

In an embodiment of this application, a thickness difference between the primary light pervious area 004 and the secondary light pervious area 005, and a thickness difference between the secondary light pervious area 005 and the second secondary light pervious area 006 is equal to or greater than 1 um.

In an embodiment of this application, the protection layer is a flat layer or a passivation layer of a material of silicon nitride and a compound thereof.

In an embodiment of this application, the black matrix layer 442 and the plurality of photo spacers 441 are made of a same material, and are integrally formed on the protection layer by using a same mask process.

In an embodiment of this application, different from controlling liquid crystal deflection angles by means of voltage division, by means of a design of the protection layer having different thicknesses, only one active switch (such as a TFT) may be used to drive an entire pixel when input voltages are the same, so that deflection angles of liquid crystal modules located in different light pervious areas differ from each other, thereby improving the color shift problem.

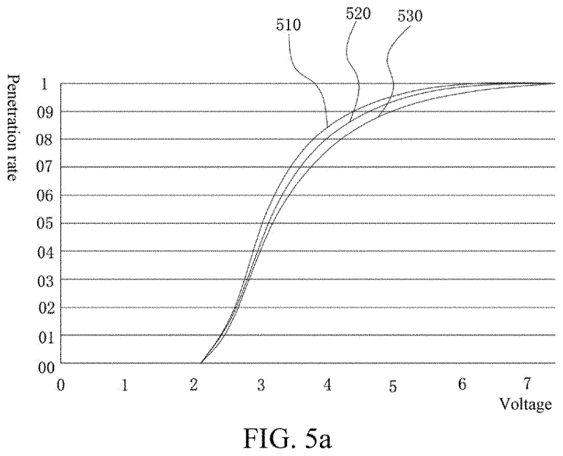

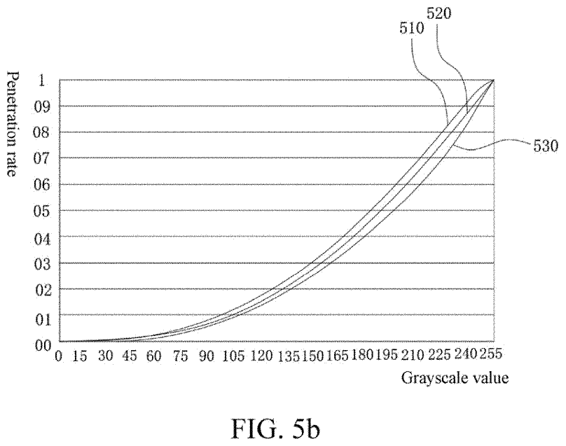

FIG. 5a is 3 GAMMA curves explained by using penetration rate-voltage curves according to an embodiment of this application. Referring to FIG. 5a, a penetration rate-voltage value curve 510 corresponding to a 3.6 liquid crystal cell gap, a penetration rate-voltage value curve 520 corresponding to a 3.9 liquid crystal cell gap, and a penetration rate-voltage value curve 530 corresponding to a 4.2 liquid crystal cell gap are shown.

FIG. 5b is 3 GAMMA curves explained by using penetration rate-grayscale value curves according to an embodiment of this application. Referring to FIG. 4a, a penetration rate-grayscale value curve 510 corresponding to a 3.6 liquid crystal cell gap, a penetration rate-grayscale value curve 520 corresponding to a 3.9 liquid crystal cell gap, and a penetration rate-grayscale value curve 530 corresponding to a 4.2 liquid crystal cell gap are shown.

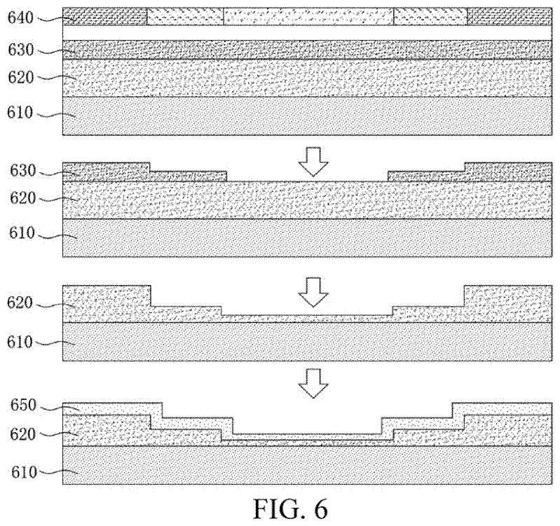

FIG. 6 is a schematic diagram of manufacturing of a protection layer with a gradient according to this application. Referring to FIG. 6, in an embodiment of this application, a method for manufacturing a display panel includes: providing a first substrate (not shown), where the first substrate includes a plurality of pixel units; forming a color resist layer 610 on the first substrate; forming a protection layer 620 on the first substrate, where the protection layer 620 covers the color resist layer 610; patterning the protection layer 620, so that the protection layer 620 forms at least three different thicknesses on each of the pixel units; and forming a transparent electrode layer 650 on the patterned protection layer 620.

In an embodiment of this application, the transparent electrode layer 650 is patterned to expose part of the protection layer 620, and a black matrix layer (not shown) and a plurality of photo spacers (not shown) are disposed on the exposed protection layer 620.

In an embodiment of this application, the light pervious areas of each of the pixel units are divided into a primary light pervious area having a first thickness, a secondary light pervious area having a second thickness, and a second secondary light pervious area having a third thickness according to different thicknesses of the light pervious areas.

In an embodiment of this application, a thickness difference between the primary light pervious area and the secondary light pervious area, and a thickness difference between the secondary light pervious area and the second secondary light pervious area is equal to or greater than 1 um.

In an embodiment of this application, when the protection layer 620 is patterned, the protection layer is patterned by using a half-tone mask 640, and the mask 640 includes a pervious area, a half-pervious area, and a non-pervious area, so that the patterned protection layer has different thicknesses.

In an embodiment of this application, the protection layer 620 is a flat layer or a passivation layer of a material of silicon nitride and a compound thereof.

In an embodiment of this application, the black matrix layer and the plurality of photo spacers are made of a same material, and are integrally formed on the protection layer by using a same mask process.

In an embodiment of this application, specifically, to form each layer, a film forming step, an exposing step, a developing step, an etching step, and a film stripping step need to be performed, and the process needs to be repeated for 5 times to complete a substrate. The film forming step is laying a layer of thin film made of a needed material (a color resist layer 610, a protection layer 620, and a photoresist (PR) material layer 630) on a first substrate (not shown); the exposing step is developing a needed pattern of a PR 630 on the PR 630 by using a mask 640; the developing step is keeping a partial PR 630 of the pattern of the PR 630 in the last phase; the etching step is etching a needed pattern on the substrate on which the pattern of the PR 630 already exists; and the film stripping step is removing, by using the substrate on which the needed pattern has been etched, the PR 630 covering the pattern, to facilitate subsequent work. Therefore, the protection layer 620 may have different thicknesses, to form at least three light pervious areas (or light pervious areas) with different thicknesses in each of the pixel units.

This application not only can improve a pixel aperture ratio, but also can improve a color shift condition of the display panel.

Terms such as “in some embodiments” and “in various embodiments” are repeatedly used. Usually, the terms do not refer to the same embodiment; but they may also refer to the same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A display panel, comprising:
a first substrate;
a plurality of pixel units, disposed on the first substrate;
a protection layer, disposed on the first substrate and covering the pixel units, wherein in each of the pixel units, the protection layer is divided into a plurality of light pervious areas with different thicknesses; and
a transparent electrode layer, disposed on the protection layer, and covering the light pervious areas with different thicknesses of the protection layer.

2. The display panel according to claim 1, wherein the light pervious areas of each of the pixel units are divided into a primary light pervious area having a first thickness, a secondary light pervious area having a second thickness, and a second secondary light pervious area having a third thickness according to different thicknesses of the light pervious areas.

3. The display panel according to claim 2, wherein a thickness difference between the primary light pervious area and the secondary light pervious area, and a thickness difference between the secondary light pervious area and the second secondary light pervious area is equal to or greater than 1 um.

4. The display panel according to claim 1, wherein the protection layer is a flat layer of a material of silicon nitride and a compound thereof.

5. The display panel according to claim 1, wherein the protection layer is a passivation layer of a material of silicon nitride and a compound thereof.

6. The display panel according to claim 1, further comprising a black matrix layer and a plurality of photo spacers disposed on the protection layer.

7. The display panel according to claim 6, wherein the black matrix layer and the plurality of photo spacers are made of a same material, and are integrally formed on the protection layer by using a same mask process.

8. A method for manufacturing a display panel, comprising:
providing a first substrate, wherein the first substrate comprises a plurality of pixel units;
forming a color resist layer on the first substrate;
forming a protection layer on the first substrate, wherein the protection layer covers the color resist layer;
patterning the protection layer, so that the protection layer forms a plurality of different thicknesses on each of the pixel units;
forming a transparent electrode layer on the patterned protection layer; and
patterning the transparent electrode layer, exposing part of the protection layer, and forming a black matrix layer and a plurality of photo spacers on the exposed protection layer.

9. The method for manufacturing a display panel according to claim 8, wherein the light pervious areas of each of the pixel units are divided into a primary light pervious area having a first thickness, a secondary light pervious area having a second thickness, and a second secondary light pervious area having a third thickness according to different thicknesses of the light pervious areas.

10. The method for manufacturing a display panel according to claim 9, wherein a thickness difference between the primary light pervious area and the secondary light pervious area, and a thickness difference between the secondary light pervious area and the second secondary light pervious area is equal to or greater than 1 um.

11. The method for manufacturing a display panel according to claim 8, wherein when the protection layer is patterned, the protection layer is patterned by using a half-tone mask, and the mask comprises a pervious area, a half-pervious area, and a non-pervious area, so that the patterned protection layer has different thicknesses.

12. The method for manufacturing a display panel according to claim 8, wherein the protection layer is a flat layer of a material of silicon nitride and a compound thereof.

13. The method for manufacturing a display panel according to claim 8, wherein the protection layer is a passivation layer of a material of silicon nitride and a compound thereof.

14. The method for manufacturing a display panel according to claim 8, wherein the black matrix layer and the plurality of photo spacers are disposed on the protection layer by using a same mask process, and the black matrix layer and the plurality of photo spacers are made of a same material.

15. A display apparatus, comprising:
a backlight module; and
a display panel, comprising:
a first substrate;
a plurality of pixel units, disposed on the first substrate;
a protection layer, disposed on the first substrate and covering the pixel units, wherein in each of the pixel units, the protection layer is divided into a plurality of light pervious areas with different thicknesses;
a transparent electrode layer, disposed on the protection layer, and covering the light pervious areas with different thicknesses of the protection layer;
a second substrate, disposed opposite to the first substrate; and
a liquid crystal layer (LC layer), disposed between the first substrate and the second substrate.
